(19) United States
(12) Patent Application Publication
(10) Pub. No.: US 2026/0135673 A1
(43) Pub. Date: May 14, 2026

(54) SYSTEMS AND METHODS FOR HARQ FEEDBACK DISABLING WITH MULTIPLE TRANSPORT BLOCKS SCHEDULING

(71) Applicant: ZTE CORPORATION, Shenzhen (CN)

(72) Inventors: Fangyu CUI, Shenzhen (CN); Nan ZHANG, Shenzhen (CN); Wei CAO, Shenzhen (CN); Junli LI, Shenzhen (CN); Yachao YIN, Shenzhen (CN)

(73) Assignee: ZTE CORPORATION, Shenzhen (CN)

(21) Appl. No.: 19/436,477

(22) Filed: Dec. 30, 2025

Related U.S. Application Data
(63) Continuation of application No. PCT/CN2023/108715, filed on Jul. 21, 2023.

(51) Int. Cl. H04L 5/00; H04L 1/1829; H04W 72/232

(52) U.S. Cl. CPC H04L 5/0055; H04L 1/1854; H04L 5/0094; H04W 72/232

(57) ABSTRACT

Presented are systems and methods for hybrid automatic repeat request (HARQ) feedback disabling with multiple transport blocks (TBs) scheduling. A wireless communication device may receive at least one configuration of multiple transport blocks (TBs) and hybrid automatic repeat request (HARQ) related information via at least one signaling from a wireless communication node. The wireless communication device may generate at least one HARQ feedback of the multiple TBs according to the at least one configuration. The at least one configuration may comprise an indication of whether bundling for the at least one HARQ feedback is configured.

### CROSS-REFERENCE TO RELATED APPLICATION

This application claims the benefit of priority under 35 U.S.C. § 120 as a continuation of International Patent Application No. PCT/CN2023/108715, filed on Jul. 21, 2023, the disclosure of which is incorporated herein by reference in its entirety.

### TECHNICAL FIELD

The disclosure relates generally to wireless communications, including but not limited to systems and methods for hybrid automatic repeat request (HARQ) feedback disabling with multiple transport blocks (TBs) scheduling.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., a user equipment (UE)) may receive at least one configuration of multiple transport blocks (TBs) and hybrid automatic repeat request (HARQ) related information via at least one signaling from a wireless communication node. The wireless communication device may generate at least one HARQ feedback (e.g., HARQ-ACK information) of the multiple TBs according to the at least one configuration. The at least one configuration may comprise an indication of whether bundling for the at least one HARQ feedback is configured. In some embodiments, there can be multiple configurations (e.g., whether bundling is enabled, or whether feedback is disabled). The multiple configurations may be configured via different signaling. The bundling for HARQ feedback may refer to an aggregation of feedback for multiple transport blocks or HARQ processes into a single transmission. The multiple TBs can be scheduled by a single downlink control information (DCI) or a single physical downlink control channel (PDCCH). The at least one signaling may comprise at least one of: a downlink control information (DCI) signaling; a higher layer signaling; a medium access control control element (MAC CE) signaling; or a radio resource control (RRC) signaling. The multiple TBs may include at least one TB that is HARQ feedback disabled.

In some embodiments, the at least one configuration may further comprise at least one of: an indication of whether one or more TBs of the multiple TBs in the same bundle is to be associated with same HARQ process; an indication of whether feedback for at least one HARQ process is enabled or disabled; or an indication of whether at least one TB of the multiple TBs is HARQ feedback enabled or disabled.

In response to the bundling for the at least one HARQ feedback being not configured, the wireless communication device may generate the at least one HARQ feedback for one or more TBs of the multiple TBs that are HARQ feedback enabled. For enhanced machine-type communication (eMTC), multiple bundles can be divided. An AND operation can be performed per bundle.

In response to the bundling for the at least one HARQ feedback being configured, the wireless communication device may generate an aggregate HARQ feedback for a bundle of one or more of the multiple TBs, via a logical AND operation of individual HARQ feedback. The aggregate HARQ feedback can be a result of a logical AND operation of individual HARQ feedback in the bundle. In response to the bundling for the at least one HARQ feedback being configured and the at least one TB of the multiple TBs being HARQ feedback enabled, the wireless communication device may generate an aggregate HARQ feedback via a logical AND operation of individual HARQ feedback corresponding to the at least one TB of the multiple TBs. The wireless communication device may generate the aggregate HARQ feedback by excluding HARQ feedback of one or more TBs of the multiple TBs that are HARQ feedback disabled, from the logical AND operation. The wireless communication device may perform the logical AND operation by: defining a respective HARQ feedback for each TB of the multiple TBs that is HARQ feedback disabled as an acknowledgment (ACK), and including the respective HARQ feedback in the logical AND operation.

In response to the bundling for the at least one HARQ feedback being configured, the wireless communication device may generate the at least one HARQ feedback for one or more TBs of the multiple TBs that are HARQ feedback enabled.

In some embodiments, the wireless communication device may generate an aggregate HARQ feedback via a logical AND operation of individual HARQ feedback corresponding to each of the multiple TBs. The wireless communication device may generate an aggregate HARQ feedback for a bundle of one or more of the multiple TBs, via a logical AND operation of individual HARQ feedback corresponding to those of the one or more of the multiple TBs that are HARQ feedback enabled.

The at least one TB of the multiple TBs being HARQ feedback enabled may indicate that HARQ feedback is enabled for at least one HARQ process associated with the at least one TB. The at least one TB of the multiple TBs being HARQ feedback disabled may indicate that HARQ feedback is disabled for at least one HARQ process associated with the at least one TB. A transport block (TB) with enabled HARQ feedback may refer to HARQ feedback being enabled for the associated HARQ process with the TB. This may indicate that feedback reception is enabled for the corresponding HARQ process to assess the success or failure of the transmission. A transport block (TB) with disabled HARQ feedback may refer to HARQ feedback being disabled for the associated HARQ process with the TB. This may indicate that feedback reception is disabled, and the HARQ process continues without waiting for feedback to determine the outcome of the transmission.

In some embodiments, the wireless communication device may associate the at least one TB of the multiple TBs in the same bundle with at least one same HARQ process. The TBs in same bundle are associated with same HARQ process. In such way, the feedback enabled and disabled TBs may not be mixed in same bundle. The at least one same HARQ process associated with the at least one TB of the multiple TBs may comprise at least one of: HARQ process 0; HARQ process 1; M HARQ processes, wherein the HARQ process IDs are associated with the TB bundle indexes with or without an offset; M HARQ processes, wherein the at least one same HARQ process for each bundle is the one with lowest HARQ process ID in the bundle; M HARQ processes, wherein the at least one same HARQ process for each bundle is the one with highest HARQ process ID in the bundle; M HARQ processes, wherein the at least one same HARQ process for each bundle is the one associated with the at least one TB with lowest TB index in the bundle; M HARQ processes, wherein the at least one same HARQ process for each bundle is the one associated with the at least one TB with highest TB index in the bundle; or M HARQ processes with HARQ process IDs starting from the at least one same HARQ process associated with a first TB. M can be a number of bundles. In response to the at least one same HARQ process associated with the at least one TB of the multiple TBs in the same bundle being HARQ feedback disabled, the wireless communication device may generate an acknowledgment (ACK). In response to the at least one same HARQ process associated with the at least one TB of the multiple TBs in the same bundle being HARQ feedback disabled, no HARQ-ACK is generated for the at least one TB. In response to the at least one same HARQ process associated with the at least one TB of the multiple TBs in the same bundle being HARQ feedback enabled, the wireless communication device may generate an aggregate HARQ feedback for the at least one TB of the multiple TBs in the same bundle, via a logical AND operation of individual HARQ feedback. The wireless communication device may generate the at least one HARQ feedback for the bundling, according to the at least one configuration.

In some embodiments, a wireless communication node may send at least one configuration of multiple transport blocks (TBs) and hybrid automatic repeat request (HARQ) related information via at least one signaling to a wireless communication device (e.g., a UE). The wireless communication device may generate at least one HARQ feedback (e.g., HARQ-ACK information) of the multiple TBs according to the at least one configuration. The at least one configuration may comprise an indication of whether bundling for the at least one HARQ feedback is configured.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a non-terrestrial network (NTN), in accordance with some embodiments of the present disclosure;

FIG. 4 illustrates an example representation of hybrid automatic repeat request (HARQ) stalling and HARQ feedback disabling, in accordance with some embodiments of the present disclosure; and

FIG. 5 illustrates a flow diagram of an example method for hybrid automatic repeat request (HARQ) feedback disabling with multiple transport blocks (TBs) scheduling, in accordance with an embodiment of the present disclosure.

### DETAILED DESCRIPTION

### 1. Mobile Communication Technology and Environment

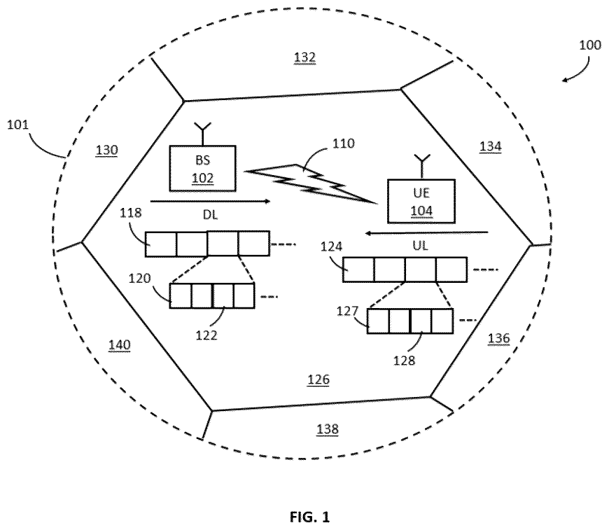

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

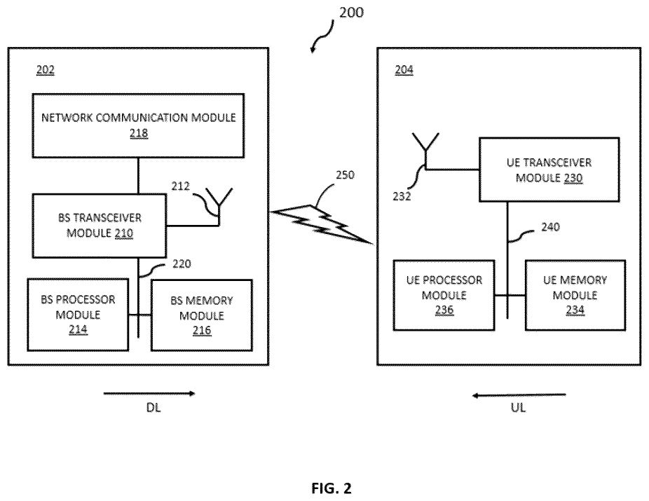

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

2. Systems and Methods for Hybrid Automatic Repeat Request (HARQ) Feedback Disabling with Multiple Transport Blocks (TBs) Scheduling

In a hybrid automatic repeat request (HARQ) mechanism, a HARQ process may perform a new transmission of retransmission after receiving feedback. However, in scenarios with long propagation delays (e.g., non-terrestrial networks (NTNs)), the HARQ process may face substantial waiting times for feedback before proceeding with the next transmission. This delay can lead to HARQ stalling, where all HARQ processes have completed transmissions, but no feedback has been received due to a large round-trip delay (RTT). To prevent HARQ stalling and increase throughput in NTN environments, the concept of HARQ feedback disabling can be considered. HARQ feedback disabling allows for the temporary deactivation of feedback reception, enabling the transmitter to continue transmitting without waiting for feedback.

However, currently the HARQ feedback disabling mechanism is focused for single TB scheduling case. When multiple TBs are scheduled by one DCI, whether/how to transmit the feedback is still pending, especially for the scenario where feedback enabled and disabled HARQ processes are scheduled by same DCI. Hence, in this disclosure, the HARQ feedback disabling mechanism for multi-TB scheduling case is investigated.

Currently, the HARQ feedback disabling mechanism primarily focuses on the case of single transport block (TB) scheduling. However, when multiple TBs are scheduled using a single downlink control information (DCI), the transmission of feedback becomes a topic of concern. Particularly, when a mix of HARQ processes with feedback enabled and disabled are scheduled using the same DCI, there can be uncertainty regarding how to handle the feedback transmission. Therefore, this disclosure investigates the HARQ feedback disabling mechanism specifically for the scenario of multi-TB scheduling. The present disclosure mitigates the impact of long delays and enhance system performance in NTN deployments for various communication applications.

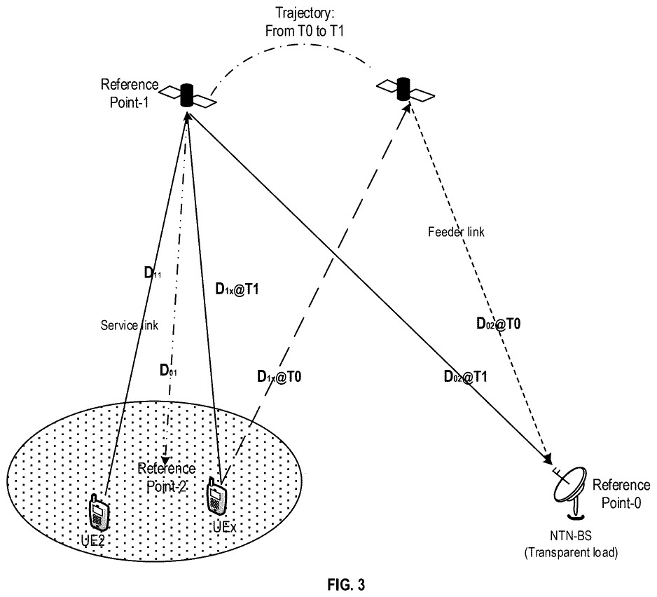

FIG. 3 illustrates an example structure of a transparent NTN, in accordance with some embodiments of the present disclosure. A link between a UE (e.g., a user equipment, the UE 104, the UE 204, a mobile device, a wireless communication device, a terminal, etc.) and a satellite can be a service link. A link between a BS (e.g., a base station, the BS 102, the BS 202, a gNB, an eNB, a wireless communication node, etc.) and a satellite can be a feeder link and can be common for all UEs within the same cell. Due to high altitude of the satellite, a propagation delay can be large. For an NTN, especially with the aerial vehicular entity in geosynchronous equatorial orbit (GEO), the RTT between the UE and the BS can be as long as several hundreds of milliseconds due to long (signal transmission/propagation) distance(s). In low earth orbit (LEO), the RTT between the UE and the BS can be a few milliseconds to tens of milliseconds.

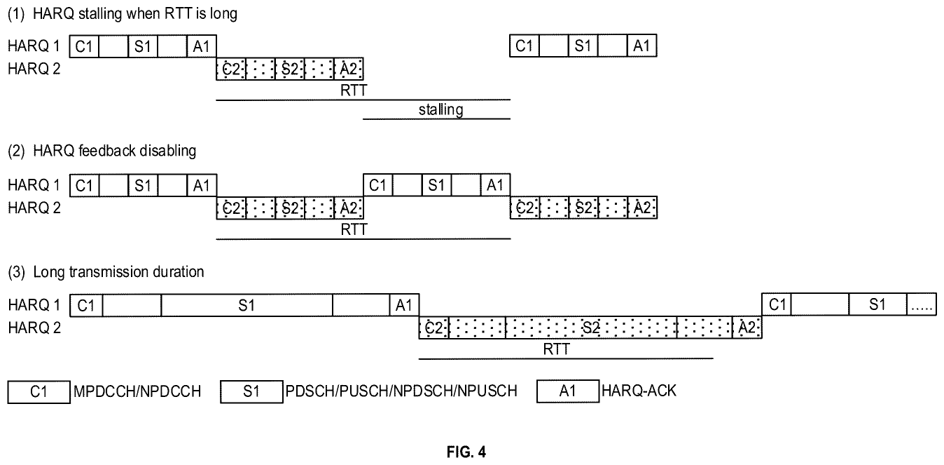

FIG. 4 illustrates representations of HARQ stalling and HARQ feedback disabling, in accordance with some embodiments of the present disclosure. The HARQ feedback disabling can be supported in new radio (NR)-NTN. By disabling the HARQ feedback for a specific HARQ process, it becomes possible to achieve continuous transmission of new transport blocks (TBs) without the need for a stop-and-wait procedure. This capability is illustrated in the second case of FIG. 2. Consequently, the occurrence of HARQ stalling, caused by significant round-trip delays (RTT), can be circumvented, leading to increased throughput. In terms of configuration, a radio resource control (RRC) based per HARQ process enabling-disabling configuration is supported, providing the necessary flexibility and control over the HARQ feedback mechanism.

In an Internet of Things (IoT)-NTN, HARQ feedback disabling may be supported. The RRC based per HARQ process enabling-disabling configuration can be supported. Moreover, downlink control information (DCI) based enabling/disabling configuration can also be supported, which can disable the feedback of scheduled TB. In contrast to New Radio (NR), narrowband IoT (NB-IoT), and enhanced Machine Type Communications (eMTC) support the scheduling of multiple transport blocks (TBs) using a single downlink control information (DCI). As a result, it is possible for both feedback-enabled and feedback-disabled HARQ processes to be scheduled using the same DCI. However, determining how to handle this scenario is still a subject of ongoing discussion and investigation. The optimal approach for managing the transmission and reception of feedback in such cases is actively explored within the NB-IoT and eMTC contexts.

### Implementation Example 1: HARQ Feedback Bundling for Mixed Feedback Enabling and Disabling

For NB-IoT and eMTC, when multiple transport blocks (TBs) are scheduled by a single downlink control information (DCI) and hybrid automatic repeat request (HARQ) bundling is applied for HARQ feedback, how to handle such case when part of the TBs are HARQ feedback disabled may present challenges that require further investigation.

In the following disclosure, HARQ feedback may refer to HARQ-ACK information. A transport block (TB) with enabled HARQ feedback may refer to HARQ feedback being enabled for the associated HARQ process with the TB. This may indicate that feedback reception is enabled for the corresponding HARQ process to assess the success or failure of the transmission. A transport block (TB) with disabled HARQ feedback may refer to HARQ feedback being disabled for the associated HARQ process with the TB. This may indicate that feedback reception is disabled, and the HARQ process continues without waiting for feedback to determine the outcome of the transmission.

For NB-IoT, a procedure for HARQ-ACK bundling when multiple TBs are scheduled by a single DCI can be as follows:

$$For {N}_{TB} > 1 ,$$

if the UE is configured with higher layer parameter harq-AckBundling in npdsch-MultiTB-Config, and the narrowband physical downlink shared channel (NPDSCH) corresponding to a narrowband physical downlink control channel (NPDCCH) with DCI cyclic redundancy check (CRC) scrambled by cell radio network temporary identifier (C-RNTI),
the ACK/NACK response can be generated by performing a logical AND operation of HARQ-ACKs corresponding to the TBᵣ₊₁, r=0.1 . . . N_{TB}−1.

The UE may perform a logical AND operation for all the ACK(s)/NACK(s) of all the TBs. That is, if at least one NACK exists, the final response for the bundled TBs can be a NACK.

When part of the TBs scheduled by the single DCI are HARQ feedback disabled, the at least one HARQ feedback disabled TB can be excluded in the bundling (e.g., not considered when performing logical AND operation). Hence, at least one of following procedures may be supported when multiple TBs are scheduled by a single DCI:

When HARQ-ACK bundling is not configured, HARQ feedback may not be generated/reported for the at least one TB with HARQ feedback disabled.

When HARQ-ACK bundling is configured and/or at least one TB is HARQ feedback enabled, the ACK/NACK response can be generated by performing a logical AND operation of HARQ-ACKs corresponding to the scheduled TBs by excluding the at least one TB with HARQ feedback disabled. For example, the ACK/NACK response can be generated by performing a logical AND operation of HARQ-ACKs corresponding to the TBᵣ₊₁, where r+1 refers to the index of at least one TB with enabled HARQ feedback. The ACK/NACK response can be generated by performing a logical AND operation of HARQ-ACKs corresponding to the TBᵣ₊₁ with enabled HARQ feedback, r=0,1, . . . N_{TB}−1.

When HARQ-ACK bundling is configured and/or at least one TB is HARQ feedback enabled, an acknowledgment (ACK) can be assumed/generated/reported for at least one TB with disabled HARQ feedback (e.g., when generating ACK/NACK response/performing logical AND operation). For example, the ACK/NACK response can be generated by performing a logical AND operation of HARQ-ACKs corresponding to the TBᵣ₊₁, r=0,1, . . . N_{TB}−1, where HARQ-ACK corresponding to at least one TB with disabled HARQ feedback are assumed as ACKs.

When all scheduled TBs are HARQ feedback disabled, HARQ feedback may not be generated/transmitted. This procedure may be applied no matter whether HARQ-ACK bundling is configured or not.

When HARQ-ACK bundling is configured, the at least one TB with HARQ feedback disabled may not be considered when generating/transmitting the ACK/NACK response. For example, if the UE is configured with higher layer parameter harq-AckBundling in npdsch-MultiTB-Config, and the narrowband physical downlink shared channel (NPDSCH) corresponding to a narrowband physical downlink control channel (NPDCCH) with DCI cyclic redundancy check (CRC) scrambled by cell radio network temporary identifier (C-RNTI), only the at least one TB with enabled HARQ feedback may be taken into account.

For eMTC, a procedure for HARQ-ACK bundling when multiple TBs are scheduled by a single DCI can be as follows:

For a bandwidth reduced low complexity/coverage enhancement (BL/CE) UE, if the UE is configured with CEModeA, and if the UE is configured with higher layer parameter harq-AckBundling in ce-PDSCH-MultiTB-Config and multiple TBs are scheduled in the corresponding DCI format 6-1A with CRC scrambled by C-RNTI,
for HARQ-ACK transmission associated with the corresponding DCI, the UE can generate M HARQ-ACK bits by performing a logical AND operation of HARQ-ACKs across all TBs in each TB bundle A_{b} where b=1, . . . , M;
the set of TBs that belong to TB bundle A_{b} and the number of TB bundles M can be given by Table 1;
the value of N_{TB} can be the number of scheduled TB determined in the corresponding DCI.

TABLE 1
Value of A_{b} and M for different values of DCI field “Multi-TB HARQ-ACK bundling
size” and for different values of number of scheduled transport blocks N_{TB}

| DCI field | | | | | |
|---|---|---|---|---|---|
| ‘Multi-TB | | | | | |
| HARQ-ACK | | | | | |
| bundling size’ | N_{TB} = 1 | N_{TB} = 2 | N_{TB} = 4 | N_{TB} = 6 | N_{TB} = 8 |
| 00 | A₁ = {TB₀ [symbol] | A₁ = {TB₀} | A₁ = {TB₀} | A₁ = {TB₀} | A₁ = {TB₀} |
| | | A₂ = {TB₁} | A₂ = {TB₁} | A₂ = {TB₁} | A₂ = {TB₁} |
| | | | A₃ = {TB₂} | A₃ = {TB₂} | A₃ = {TB₂} |
| | | | A₄ = {TB₃} | A₄ = {TB₃} | A₄ = {TB₃} |
| | | | | A₅ = {TB₄} | A₅ = {TB₄} |
| | | | | A₆ = {TB₅} | A₆ = {TB₅} |
| | | | | | A₇ = {TB₆} |
| | | | | | A₈ = {TB₇} |
| 01 | — | A₁ = {TB₀, TB₁ [symbol] | A₁ = {TB₀, TB₁} | A₁ = {TB₀, TB₁} | A₁ = {TB₀, TB₁} |
| | | | A₂ = {TB₂, TB₃} | A₂ = {TB₂, TB₃} | A₂ = {TB₂, TB₃} |
| | | | | A₃ = {TB₄, TB₅} | A₃ = {TB₄, TB₅} |
| | | | | | A₄ = {TB₆, TB₇} |
| 10 | — | — | A₁ = {TB₀, TB₁} | A₁ = {TB₀, TB₁, TB₂} | A₁ = {TB₀, TB₁, TB₂} |
| | | | A₂ = {TB₂} | A₂ = {TB₃, TB₄, TB₅} | A₂ = {TB₃, TB₄, TB₅} |
| | | | A₃ = {TB₃} | | A₃ = {TB₆, TB₇} |
| 11 | — | — | A₁ = {TB₀, TB₁, TB₂, T [symbol] | A₁ = {TB₀, TB₁, TB₂, T [symbol] | A₁ = {TB₀, TB₁, TB₂, T [symbol] |
| | | | | A₂ = {TB₄, TB₅} | A₂ = {TB₄, TB₅, TB₆, T [symbol] |

[symbol]

indicates data missing or illegible when filed

Based on different configurations of multi-TB HARQ-ACK bundling size and number of scheduled TBs, the TBs may be divided into different bundles and a logical AND operation of HARQ-ACKs can be performed across each bundle.

When part of the TBs scheduled by the single DCI are HARQ feedback disabled, enhancement may be needed since all the scheduled TBs are considered in the bundle division. The value of N_{TB}can be the number of scheduled TB determined in the corresponding DCI. At least one of following enhancements may be considered when multiple TBs are scheduled by a single DCI:

1. The bundle division can be same as current specification. The at least one HARQ feedback disabled TB in each bundle may not be taken into account when generating HARQ-ACK. For example, for HARQ-ACK transmission associated with the corresponding DCI, the UE can generate M HARQ-ACK bits by performing a logical AND operation of HARQ-ACKs across all TBs with enabled HARQ feedback in each TB bundle A_{b} where b=1, . . . , M. More specifically, by assuming N_{TB}=8 and DCI field “Multi-TB HARQ-ACK bundling size” equals to “10”, if the HARQ feedback of TB₀, TB₁, TB₅ are disabled, then the TB bundle A_{b} can be:

$${A}_{1} = \{ , T {B}_{2} \} ,$$

$${A}_{2} = \{ T {B}_{3} , T {B}_{4} , \} ,$$

$${A}_{3} = \{ T {B}_{6} , T {B}_{7} \} .$$

Strikeout TBs are not considered when performing the logical AND operation of HARQ-ACKs.

If all TBs within a bundle is feedback disabled, maybe:
ACK is generated for the bundle. For example, by assuming N_{TB}=8 and DCI field “Multi-TB HARQ-ACK bundling size” equals to “10”, if the HARQ feedback of TB₀, TB₁, TB₂, TB₅ are disabled, then 3 bundles ca be generated as:

$${A}_{1} = \{ \} ,$$

$${A}_{2} = \{ T {B}_{3} , T {B}_{4} , \} ,$$

$${A}_{3} = \{ T {B}_{6} , T {B}_{7} \} .$$

The UE can generate 3 HARQ-ACK bits, for instance. The HARQ-ACK bit for A₁ can be set as an ACK. The HARQ-ACK bit for A₂ can be generated by performing a logical AND operation of HARQ-ACKs across TB₃, TB₄. The HARQ-ACK bit for A₃ can be generated by performing a logical AND operation of HARQ-ACKs across TB₆, TB₇.
No HARQ-ACK is generated for the bundle. The number of HARQ-ACK bits M can be reduced accordingly. For example, by assuming N_{TB}=8 and DCI field “Multi-TB HARQ-ACK bundling size” equal to “10”, if the HARQ feedback of TB₀, TB₁, TB₂, TB₅ are disabled, then 3 bundles can be generated as:

$${A}_{1} = \{ \} ,$$

$${A}_{2} = \{ T {B}_{3} , T {B}_{4} , \} ,$$

$${A}_{3} = \{ T {B}_{6} , T {B}_{7} \} .$$

The UE can generate 2 HARQ-ACK bits for A₂ and A₃, respectively. The HARQ-ACK bit for A₂ can be generated by performing a logical AND operation of HARQ-ACKs across TB₃, TB₄. The HARQ-ACK bit for A₃ can be generated by performing a logical AND operation of HARQ-ACKs across TB₆, TB₇.

2. The bundle division can be same as current specification. The at least one HARQ feedback disabled TB in each bundle can be assumed/generated/reported as ACKs when generating HARQ-ACK. For example, for HARQ-ACK transmission associated with the corresponding DCI, the UE can generate M HARQ-ACK bits by performing a logical AND operation of HARQ-ACKs across all TBs in each TB bundle A_{b} where b=1, . . . , M, where HARQ-ACKs corresponding to TBs with disabled HARQ feedback are assumed as ACKs.

More specifically, by assuming N_{TB}=8 and DCI field “Multi-TB HARQ-ACK bundling size” equals to “10”, if the HARQ feedback of TB₀, TB₁, TB₅ are disabled, then the TB bundle A_{b} can be:

$${A}_{1} = \{ T {B}_{0} , T {B}_{1} , T {B}_{2} \} ,$$

$${A}_{2} = \{ T {B}_{3} , T {B}_{4} , T {B}_{5} \} ,$$

$${A}_{3} = \{ T {B}_{6} , T {B}_{7} \} .$$

HARQ-ACKs corresponding to bold TBs can be assumed as ACKs when performing the logical AND operation of HARQ-ACKs. If all TBs within a bundle is feedback disabled, similar approaches as the first enhancement can be considered.

3. The at least one HARQ feedback disabled TB can be excluded in the definition of N_{TB} and TBₓ. Then current procedure can be reused. For example,
the set of TBs that belong to TB bundle A_{b} and the number of TB bundles M are given by Table 1, where only the at least one TB with enabled HARQ feedback can be taken into account;
the value of N_{TB}can be the number of scheduled TB with enabled HARQ feedback determined in the corresponding DCI.

More specifically, when 8 TBs are scheduled by a DCI but only 4 TBs with enabled HARQ feedback, then N_{TB}=4. By assuming that DCI field “Multi-TB HARQ-ACK bundling size” equals to “10”, then 3 bundles can be generated as:

$${A}_{1} = \{ T {B}_{0} , T {B}_{1} \} ,$$

$${A}_{2} = \{ T {B}_{2} \} ,$$

$${A}_{3} = \{ T {B}_{3} \} .$$

TB₀, TB₁, TB₂, TB₃ may refer to the TBs scheduled by the DCI with enabled HARQ feedback. The TBs with disabled HARQ feedback may not be taken into account in the HARQ-ACK generating procedure.

If the number of TBs with enabled HARQ feedback N_{TB,enable} does not match to any of candidate N_{TB} value in the Table 1, enhancement may be needed. For example, the smallest candidate N_{TB} value that is larger than or equal to the number of TBs with enabled HARQ feedback can be applied. For TB bundling, the TBs with enabled HARQ feedback can be allocated to the TB bundle A_{b} in sequence. For the N_{TB,enable}−N_{TB} free spaces in TB bundling, at least one of followings can be considered:
the free spaces may not be taken into account when generating HARQ-ACK.
ACK can be assumed/generated for the free spaces when generating HARQ-ACK.
No HARQ-ACK bit can be generated for a TB bundle which does not contain TB with enabled HARQ feedback.

More specifically, when 8 TBs are scheduled by a DCI but only 3 TBs with enabled HARQ feedback, then apply N_{TB}=4 for TB bundling. By assuming that DCI field “Multi-TB HARQ-ACK bundling size” equals to “10”, then 3 bundles can be generated as:

$${A}_{1} = \{ T {B}_{0} , T {B}_{1} \} ,$$

$${A}_{2} = \{ T {B}_{2} \} ,$$

$${A}_{3} = \{ \} .$$

TB₀, TB₁, TB₂ may refer to the TBs scheduled by the DCI with enabled HARQ feedback. The UE may:
generate 2 HARQ-ACK bits for A₁ and A₂, respectively. For A₃, no HARQ-ACK information is generated/transmitted.
generate 3 HARQ-ACK bits for A₁, A₂, and A₃, respectively. For A₃, ACK is generated.
   Moreover, if all the TBs are feedback disabled, no HARQ-ACK is generated/transmitted.
   Implementation Example 2: Association Between TB and HARQ Process when HARQ Feedback Bundling Configured

In implementation example 1, each TB is associated with an independent HARQ process. Therefore, feedback enabled and disabled TBs may be bundled. If the association between TB and HARQ process is enhanced, the case to bundle HARQ feedback enabled and disabled TBs may be avoided. For example, when multiple TBs are scheduled by single DCI and HARQ-ACK bundling is configured, the TBs in the same bundle can be associated with same HARQ process or carried by same (N) PDSCH.

For NB-IoT, when multiple TBs are scheduled by single DCI and HARQ-ACK bundling is configured, the scheduled TBs may be associated with same HARQ process or carried by same NPDSCH. If the associated HARQ process is HARQ-ACK enabled, the ACK/NACK response can be generated by performing a logical AND operation of HARQ-ACKs corresponding to the scheduled TBs. If the associated HARQ process is HARQ-ACK disabled, at least one of followings may be considered:
HARQ feedback is not generated/transmitted; or
ACK is generated/transmitted.

For eMTC, when multiple TBs are scheduled by a single DCI and HARQ-ACK bundling is configured, the TBs within same bundle are associated with same HARQ process or carried by same PDSCH. The TB bundling procedure as shown in implementation example 1 may be reused. For the TB bundle associated with HARQ feedback enabled HARQ process, a logical AND operation can be performed across all TBs within the bundle. For the TB bundle associated with HARQ feedback disabled HARQ process, at least one of followings may be considered:
HARQ feedback is not generated/transmitted for the TB bundle; or
ACK is generated/transmitted for the TB bundle.

More specifically, when 8 TBs are scheduled by a DCI and DCI field “Multi-TB HARQ-ACK bundling size” equals to “10”, then 3 bundles can be generated as:

$${A}_{1} = \{ T {B}_{0} , T {B}_{1} , T {B}_{2} \} ,$$

$${A}_{2} = \{ T {B}_{3} , T {B}_{4} , T {B}_{5} \} ,$$

$${A}_{3} = \{ T {B}_{6} , T {B}_{7} \} .$$

The TB bundles A₁, A₂, and A₃ can be associated with 3 different HARQ processes. Assume that A₁ is associated with a HARQ process with HARQ-ACK disabled, while A₂ and A₃ are associated with HARQ processes with HARQ-ACK enabled.
The UE can generate 2 HARQ-ACK bits for A₂ and A₃, respectively. The HARQ-ACK bit for A₂ can be generated by performing a logical AND operation of HARQ-ACKs across TB₃, TB₄, TB₅. The HARQ-ACK bit for A₃ can be generated by performing a logical AND operation of HARQ-ACKs across TB₆, TB₇; or
The UE can generate 3 HARQ-ACK bits for A₁, A₂ and A₃, respectively. The HARQ-ACK bit for A₁ can be set as ACK. The HARQ-ACK bit for A₂ can be generated by performing a logical AND operation of HARQ-ACKs across TB₃, TB₄, TB₅. The HARQ-ACK bit for A₃ can be generated by performing a logical AND operation of HARQ-ACKs across TB₆, TB₇.

The UE may receive an indication from a network on whether the TBs in the same bundle can be associated with same HARQ process or carried by same (N) PDSCH. The indication may be explicit or implicit. For explicit indication, the network may send an signaling to the UE on whether the TBs in the same bundle can be associated with same HARQ process or carried by same (N) PDSCH via at least one of an radio resource control (RRC) signaling, a medium access control control element (MAC CE) signaling, a downlink control information (DCI) signaling, or a system information block (SIB) broadcast. For implicit indication, the UE may associate the TBs in the same bundle with same HARQ process when at least one HARQ process is configured feedback disabled.

When the TBs in same bundle are associated with same HARQ process, which HARQ process is associated with the bundle can be considered. For NB-IoT, all the TBs are in same bundle if HARQ-ACK bundling can be configured. The UE with HARQ-ACK bundling may have at most two HARQ processes. Therefore, when multiple TBs are scheduled by a single DCI and HARQ-ACK bundling is configured, the HARQ process associated with the scheduled TBs may comprise at least one of: HARQ process 0; or HARQ process 1.

For eMTC, the TBs may be divided into multiple bundles. Therefore, when multiple TBs are scheduled by a single DCI and HARQ-ACK bundling is configured, the HARQ processes associated with TB bundles can be: M HARQ processes, where the HARQ process IDs are associated with the TB bundle indexes with or without an offset; M HARQ processes, where the HARQ process for each bundle is the one with lowest HARQ process ID in the bundle; M HARQ processes, where the HARQ process for each bundle is the one with highest HARQ process ID in the bundle; M HARQ processes with HARQ process IDs starting from the HARQ process associated with the first TB; M HARQ processes, where the HARQ process for each bundle is the one associated with the TB with lowest TB index in the bundle; M HARQ processes, where the HARQ process for each bundle is the one associated with the TB with highest TB index in the bundle; M HARQ processes with HARQ process IDs starting from the HARQ process associated with the first TB; where M can be the number of TB bundles.

For the HARQ process IDs associated with the TB bundle indexes, at least one of following examples may be considered:
M HARQ processes are associated with the TB bundles sequentially with HARQ process IDs equal to TB bundle indexes. For example, HARQ process 1 is associated with TB bundle A₁, HARQ process 2 is associated with TB bundle A₂, and so on.
M HARQ processes starting from the one with lowest HARQ process ID (e.g., starting from HARQ process 0) are associated with the TB bundles sequentially based on the TB bundle index. For example, HARQ process 0 is associated with TB bundle A₁, HARQ process 1 is associated with TB bundle A₂, and so on.
M HARQ processes ending with the one with highest HARQ process ID (e.g., ending with HARQ process 7) are associated with the TB bundles sequentially based on the TB bundle index. For example, HARQ process 7 is associated with TB bundle A_{M}, HARQ process 6 is associated with TB bundle A_{M-1}, and so on.
M HARQ processes are associated with the TB bundles sequentially with an offset between HARQ process IDs and TB bundle indexes. For example, assuming the offset is X. Then, HARQ process 1+X is associated with TB bundle A₁, HARQ process 2+X is associated with TB bundle A₂, and so on. X can be zero, positive or negative. Modulo operation based on HARQ process number may be performed if the TB bundle index plus offset exceeding the value range of HARQ process IDs.
For the association in above examples, may only consider available HARQ processes. When a HARQ process is already being used, it may be skipped in the association between HARQ process and TB bundle. The following HARQ processes are associated with the TB bundles sequentially. For example, assuming HARQ processes 1 to M are originally to be associated with TB bundles A₁ to A_{M}. However, HARQ process Y has already been used. Then HARQ processes 1 to Y−1 can be associated with TB bundles A₁ to A_{Y-1}, and HARQ processes Y+1 to M+1 can be associated with TB bundles A_{Y} to A_{M}.

For M HARQ processes where the HARQ process for each bundle is the one with lowest HARQ process ID in the bundle, more specifically, lowest HARQ process ID may refer to the lowest HARQ process ID among the HARQ processes originally associated with the TBs in the TB bundle. For example, assuming 8 TBs are scheduled and divided into 3 bundles as shown below

$${A}_{1} = \{ T {B}_{0} , T {B}_{1} , T {B}_{2} \} ,$$

$${A}_{2} = \{ T {B}_{3} , T {B}_{4} , T {B}_{5} \} ,$$

$${A}_{3} = \{ T {B}_{6} , T {B}_{7} \} .$$

Each TB may be associated with a unique HARQ process. Without loss of generality, assume that HARQ processes 0-7 are originally associated with TB₀ to TB₇. Then for TB bundle A₁, the HARQ processes can be HARQ processes 0-2. The lowest HARQ process ID in bundle A₁ is HARQ process 0. Similarly, the lowest HARQ process IDs for TB bundle A₂ and A₃ can be HARQ process 3 and HARQ process 6, respectively. For M HARQ processes where the HARQ process for each bundle is the one with highest HARQ process ID in the bundle, similar as above.

It should be understood that one or more features from the above implementation examples are not exclusive to the specific implementation examples, but can be combined in any manner (e.g., in any priority and/or order, concurrently or otherwise).

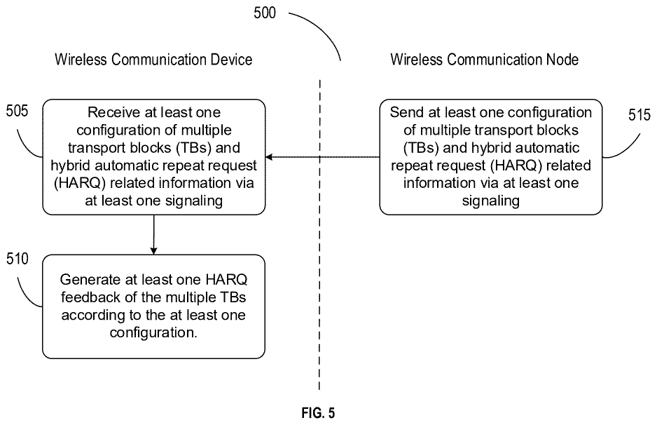

FIG. 5 illustrates a flow diagram of a method 500 for hybrid automatic repeat request (HARQ) feedback disabling with multiple transport blocks (TBs) scheduling. The method 500 may be implemented using any one or more of the components and devices detailed herein in conjunction with FIGS. 1-4. In overview, the method 500 may be performed by a wireless communication device (e.g., a UE), in some embodiments. Additional, fewer, or different operations may be performed in the method 500 depending on the embodiment. At least one aspect of the operations is directed to a system, method, apparatus, or a computer-readable medium.

A wireless communication device (e.g., a user equipment (UE)) may receive at least one configuration of multiple transport blocks (TBs) and hybrid automatic repeat request (HARQ) related information via at least one signaling from a wireless communication node. The wireless communication device may generate at least one HARQ feedback (e.g., HARQ-ACK information) of the multiple TBs according to the at least one configuration. The at least one configuration may comprise an indication of whether bundling for the at least one HARQ feedback is configured. In some embodiments, there can be multiple configurations (e.g., whether bundling is enabled, or whether feedback is disabled). The multiple configurations may be configured via different signaling. The multiple TBs can be scheduled by a single downlink control information (DCI) or a single physical downlink control channel (PDCCH). The at least one signaling may comprise at least one of: a downlink control information (DCI) signaling; a higher layer signaling; a medium access control control element (MAC CE) signaling; or a radio resource control (RRC) signaling. The multiple TBs may include at least one TB that is HARQ feedback disabled.

In some embodiments, the at least one configuration may further comprise at least one of: an indication of whether one or more TBs of the multiple TBs in the same bundle is to be associated with same HARQ process; an indication of whether feedback for at least one HARQ process is enabled or disabled; or an indication of whether at least one TB of the multiple TBs is HARQ feedback enabled or disabled.

In response to the bundling for the at least one HARQ feedback being not configured, the wireless communication device may generate the at least one HARQ feedback for one or more TBs of the multiple TBs that are HARQ feedback enabled. For enhanced machine-type communication (eMTC), multiple bundles can be divided. An AND operation can be performed per bundle.

In response to the bundling for the at least one HARQ feedback being configured, the wireless communication device may generate an aggregate HARQ feedback for a bundle of one or more of the multiple TBs, via a logical AND operation of individual HARQ feedback. In response to the bundling for the at least one HARQ feedback being configured and the at least one TB of the multiple TBs being HARQ feedback enabled, the wireless communication device may generate an aggregate HARQ feedback via a logical AND operation of individual HARQ feedback corresponding to the at least one TB of the multiple TBs. The wireless communication device may generate the aggregate HARQ feedback by excluding HARQ feedback of one or more TBs of the multiple TBs that are HARQ feedback disabled, from the logical AND operation. The wireless communication device may perform the logical AND operation by: defining a respective HARQ feedback for each TB of the multiple TBs that is HARQ feedback disabled as an acknowledgment (ACK), and including the respective HARQ feedback in the logical AND operation.

In response to the bundling for the at least one HARQ feedback being configured, the wireless communication device may generate the at least one HARQ feedback for one or more TBs of the multiple TBs that are HARQ feedback enabled.

In some embodiments, the wireless communication device may generate an aggregate HARQ feedback via a logical AND operation of individual HARQ feedback corresponding to each of the multiple TBs. The wireless communication device may generate an aggregate HARQ feedback for a bundle of one or more of the multiple TBs, via a logical AND operation of individual HARQ feedback corresponding to those of the one or more of the multiple TBs that are HARQ feedback enabled.

The at least one TB of the multiple TBs being HARQ feedback enabled may indicate that HARQ feedback is enabled for at least one HARQ process associated with the at least one TB. The at least one TB of the multiple TBs being HARQ feedback disabled may indicate that HARQ feedback is disabled for at least one HARQ process associated with the at least one TB.

In some embodiments, the wireless communication device may associate (e.g., map, relate, correspond, pair) the at least one TB of the multiple TBs in the same bundle with at least one same HARQ process. The TBs in same bundle are associated with same HARQ process. In such way, the feedback enabled and disabled TBs may not be mixed in same bundle. The at least one same HARQ process associated with the at least one TB of the multiple TBs may comprise at least one of: HARQ process 0; HARQ process 1; M HARQ processes, wherein the HARQ process IDs are associated with the TB bundle indexes with or without an offset; M HARQ processes, wherein the at least one same HARQ process for each bundle is the one with lowest HARQ process ID in the bundle; M HARQ processes, wherein the at least one same HARQ process for each bundle is the one with highest HARQ process ID in the bundle; M HARQ processes, wherein the at least one same HARQ process for each bundle is the one associated with the at least one TB with lowest TB index in the bundle; M HARQ processes, wherein the at least one same HARQ process for each bundle is the one associated with the at least one TB with highest TB index in the bundle; or M HARQ processes with HARQ process IDs starting from the at least one same HARQ process associated with a first TB. M can be a number of bundles. In response to the at least one same HARQ process associated with the at least one TB of the multiple TBs in the same bundle being HARQ feedback disabled, the wireless communication device may generate an acknowledgment (ACK). In response to the at least one same HARQ process associated with the at least one TB of the multiple TBs in the same bundle being HARQ feedback disabled, no HARQ-ACK is generated for the at least one TB. In response to the at least one same HARQ process associated with the at least one TB of the multiple TBs in the same bundle being HARQ feedback enabled, the wireless communication device may generate an aggregate HARQ feedback for the at least one TB of the multiple TBs in the same bundle, via a logical AND operation of individual HARQ feedback. The wireless communication device may generate the at least one HARQ feedback for the bundling, according to the at least one configuration.

In some embodiments, a wireless communication node may send at least one configuration of multiple transport blocks (TBs) and hybrid automatic repeat request (HARQ) related information via at least one signaling to a wireless communication device (e.g., a UE). The wireless communication device may generate at least one HARQ feedback (e.g., HARQ-ACK information) of the multiple TBs according to the at least one configuration. The at least one configuration may comprise an indication of whether bundling for the at least one HARQ feedback is configured.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method comprising:
receiving, by a wireless communication device from a wireless communication node, at least one configuration of multiple transport blocks (TBs) and hybrid automatic repeat request (HARQ) related information via at least one signaling; and
generating, by the wireless communication device, at least one HARQ feedback of the multiple TBs according to the at least one configuration,
wherein the at least one configuration comprises an indication of whether bundling for the at least one HARQ feedback is configured.

2. The method of claim 1, wherein the multiple TBs are scheduled by a single downlink control information (DCI).

3. The method of claim 1, wherein the multiple TBs include at least one TB that is HARQ feedback disabled.

4. The method of claim 1, wherein the at least one configuration further comprises:
an indication of whether feedback for at least one HARQ process is enabled or disabled.

5. The method of claim 1, comprising:
in response to the bundling for the at least one HARQ feedback being not configured, generating, by the wireless communication device, the at least one HARQ feedback for one or more TBs of the multiple TBs that are HARQ feedback enabled.

6. The method of claim 1, comprising:
in response to the bundling for the at least one HARQ feedback being configured and the at least one TB of the multiple TBs being HARQ feedback enabled, generating, by the wireless communication device, an aggregate HARQ feedback via a logical AND operation of individual HARQ feedback corresponding to the at least one TB of the multiple TBs.

7. The method of claim 6, comprising:
performing, by the wireless communication device, the logical AND operation by: defining a respective HARQ feedback for each TB of the multiple TBs that is HARQ feedback disabled as an acknowledgment (ACK), and including the respective HARQ feedback in the logical AND operation.

8. A wireless communication device comprising:
at least one processor configured to:
receive, via a receiver from a wireless communication node, at least one configuration of multiple transport blocks (TBs) and hybrid automatic repeat request (HARQ) related information via at least one signaling; and
generate at least one HARQ feedback of the multiple TBs according to the at least one configuration,
wherein the at least one configuration comprises an indication of whether bundling for the at least one HARQ feedback is configured.

9. The wireless communication device of claim 8, wherein the multiple TBs are scheduled by a single downlink control information (DCI).

10. The wireless communication device of claim 8, wherein the multiple TBs include at least one TB that is HARQ feedback disabled.

11. The wireless communication device of claim 8, wherein the at least one configuration further comprises:
an indication of whether feedback for at least one HARQ process is enabled or disabled.

12. The wireless communication device of claim 8, wherein the at least one processor is configured to:
in response to the bundling for the at least one HARQ feedback being not configured, generate the at least one HARQ feedback for one or more TBs of the multiple TBs that are HARQ feedback enabled.

13. The wireless communication device of claim 8, wherein the at least one processor is configured to:
in response to the bundling for the at least one HARQ feedback being configured and the at least one TB of the multiple TBs being HARQ feedback enabled, generating an aggregate HARQ feedback via a logical AND operation of individual HARQ feedback corresponding to the at least one TB of the multiple TBs.

14. The wireless communication device of claim 13, wherein the at least one processor is configured to:
perform the logical AND operation by: defining a respective HARQ feedback for each TB of the multiple TBs that is HARQ feedback disabled as an acknowledgment (ACK), and including the respective HARQ feedback in the logical AND operation.

15. A method comprising:
sending, by a wireless communication node to a wireless communication device, at least one configuration of multiple transport blocks (TBs) and hybrid automatic repeat request (HARQ) related information via at least one signaling, to cause the wireless communication device to generate at least one HARQ feedback of the multiple TBs according to the at least one configuration,
wherein the at least one configuration comprises an indication whether bundling for the at least one HARQ feedback is configured.

16. The method of claim 15, wherein the multiple TBs are scheduled by a single downlink control information (DCI).

17. A wireless communication node comprising:
at least one processor configured to:
sending, via a transmitter to a wireless communication device, at least one configuration of multiple transport blocks (TBs) and hybrid automatic repeat request (HARQ) related information via at least one signaling, to cause the wireless communication device to generate at least one HARQ feedback of the multiple TBs according to the at least one configuration,
wherein the at least one configuration comprises an indication whether bundling for the at least one HARQ feedback is configured.

18. The wireless communication node of claim 17, wherein the multiple TBs are scheduled by a single downlink control information (DCI).

19. The wireless communication node of claim 17, wherein the multiple TBs include at least one TB that is HARQ feedback disabled.

20. The wireless communication node of claim 17, wherein the at least one configuration further comprises:
an indication of whether feedback for at least one HARQ process is enabled or disabled.
